(19) United States
(12) Patent Application Publication
(10) Pub. No.: US 2017/0269733 A1
(43) Pub. Date: Sep. 21, 2017

(54) SYSTEM AND METHOD FOR VIRTUAL REALITY VIEWER

(71) Applicant: DODOcase, Inc., San Francisco, CA (US)

(72) Inventor: Patrick Regan Buckley, Mill Valley, CA (US)

(73) Assignee: DODOcase Inc, San Francisco, CA (US)

(21) Appl. No.: 15/362,817

(22) Filed: Nov. 29, 2016

Related U.S. Application Data
(60) Provisional application No. 62/260,326, filed on Nov. 26, 2015.

(51) Int. Cl. G06F 3/044; G06F 1/16; G06F 3/01

(52) U.S. Cl. CPC G06F 3/044; G06F 3/011; G06F 1/163; G06F 2203/04107

(57) ABSTRACT

A foldable virtual reality viewer for use with smartphone devices is provided. The viewer is configured to be transitioned between a collapsed state to an expanded, operative state. The viewer comprises a housing configured to receive a mobile device therein. In order to facilitate transitioning the viewer between the flat and operative states, a main body of the viewer comprises a substrate having a series of panels defining a top, bottom, left and right walls and folds between adjacent panels in the series. The series of panels are attached at ends thereof to define a collapsible sequence of panels/walls that bound an interior volume of the viewer. In addition, a faceplate is attached to an interior surface within the main body such that it pivots within the interior when transitioning the viewer between the expanded state and the collapsed state.

### CROSS-REFERENCE TO RELATED APPLICATIONS

The present application claims benefit of U.S. Provisional Patent Application Ser. No. 62/260,326 entitled “System and Method for Virtual Reality Viewer” filed on Nov. 26, 2015, which is hereby incorporated by reference as if set forth in its respective entireties herein.

### TECHNICAL FIELD OF THE INVENTION

The present invention relates to virtual reality viewer devices, in particular, virtual reality viewer devices for use with personal mobile electronic devices and having an input device.

### BACKGROUND OF THE INVENTION

Virtual reality viewers and headsets (collectively referred to as viewers) are becoming an increasingly popular way of viewing digital media, gaming and the like. With the widespread distribution of powerful and capable smartphone devices, many VR viewers are designed to use such smartphone devices as the visual display device, instead of having dedicated displays and electronics.

Typically the viewers have a housing that a user looks into in order to view the video display device contained within the housing. Viewers can be hand-held devices that a user holds up to the users face/eyes, for example, like a user would hold a pair of binoculars. Viewers can also be worn on a user's head, so as to free the user's hands while looking into the viewer.

As would be understood by those in the art, viewers configured to use a smartphone as the visual display device typically receive the smartphone such that the smart phone display is viewable when a user looks into the viewer housing. These viewers also typically include one or more optical lenses within the housing so as to facilitate a three-dimensional viewing experience despite the two-dimensional display of the smartphone. In some instances, the smartphone is completely contained within the housing, in other implementations the smartphone is attached to the housing in a manner such that the display is exposed within the interior of the viewer.

One challenge to utilizing a smartphone in these types of viewers is that the touch sensitive display is concealed within the viewer housing, thereby making it difficult for a user to interact with the touch sensitive display of the device. To overcome this, some existing VR viewers utilize magnets on the exterior of the viewer as input devices, however one drawback is that the locations of magnetic sensors on smartphones vary from device to device and, as such, these viewers with magnetic inputs are only effectively used with a limited number of devices. Other VR viewers utilize built in accelerometers or other such position/orientation sensors within the smartphone to detect movement or the absence of movement and identify user inputs using the movement data. Other VR viewers utilize dedicated input devices, like video game controllers, that connect to the electronic device within the viewer either by a wired plug like connection (e.g., USB or Apple compatible connector), or a wireless connection capabilities. However, such VR viewer configurations typically require complex electronic circuitry and wireless connectivity capabilities in order to facilitate the capture and transfer of user inputs. Moreover, dedicated input controllers can be cumbersome when used with hand-held viewer.

What is needed is a VR viewer having integrated user input devices that is configured for use with a wide variety of conventionally available smartphone devices.

These considerations are addressed by the present invention.

### SUMMARY OF THE INVENTION

The present invention concerns systems and methods for a virtual reality viewer substantially shown and described herein.

These and other aspects, features, steps and advantages can be further appreciated from the accompanying figures and description of certain illustrative embodiments.

### BRIEF DESCRIPTION OF THE DRAWINGS

FIG. 1 illustrates an exemplary virtual reality viewer.

FIG. 2 illustrates the viewer of FIG. 1.

FIG. 3 illustrates the viewer of FIG. 1.

FIG. 4 illustrates an exemplary virtual reality viewer.

FIG. 5 illustrates an exemplary virtual reality viewer.

FIG. 6A illustrates an exemplary virtual reality viewer including an input mechanism in accordance with an embodiment of the invention.

FIG. 6B illustrates the viewer of FIG. 6A.

FIG. 7A illustrates an exemplary input mechanism for a virtual reality viewer in accordance with an embodiment of the invention.

FIG. 7B illustrates the exemplary input mechanism for a virtual reality viewer of FIG. 7A.

FIG. 7C illustrates a virtual reality viewer including the input mechanism of FIG. 7A.

FIG. 7D illustrates the exemplary viewer and input mechanism of FIG. 7C.

FIG. 7E illustrates the exemplary viewer and input mechanism of FIG. 7C.

FIG. 7F illustrates the exemplary viewer and input mechanism of FIG. 7C.

FIG. 8A is a front perspective view of an exemplary foldable virtual reality viewer in an operative state in accordance with an embodiment of the invention.

FIG. 8B is a bottom perspective view of the viewer of FIG. 8A in a collapsed state in accordance with an embodiment of the invention.

FIG. 8C is a side perspective view of the viewer of FIG. 8A in accordance with an embodiment of the invention.

FIG. 8D is a side perspective view of the viewer of FIG. 8A in accordance with an embodiment of the invention.

FIG. 8E is a rear perspective view of the viewer of FIG. 8A in accordance with an embodiment of the invention.

FIG. 8F is a bottom view of the viewer of FIG. 8A during transition of the viewer into an operative state in accordance with an embodiment of the invention.

FIG. 8G is a top view of the viewer of FIG. 8A during transition of the viewer into an operative state in accordance with an embodiment of the invention.

FIG. 8H is a top perspective view of the viewer of FIG. 8A during transition of the viewer into an operative state in accordance with an embodiment of the invention.

FIG. 8I is a front view of the viewer of FIG. 8A prior to folding the view divider into place in accordance with an embodiment of the invention.

FIG. 8J is a top view of the viewer of FIG. 8A in a collapsed and unfolded state in accordance with an embodiment of the invention.

FIG. 9 is an exemplary dieline of an unfolded and unassembled viewer.

### DETAILED DESCRIPTION OF THE INVENTION

According to an aspect of the subject application, Virtual reality viewer systems and methods are provided that facilitate the capture of user inputs while using the virtual reality viewer. More specifically, the disclosed systems and methods provide a virtual reality viewer for use with a wide variety of personal electronic devices (e.g., a smartphone) as the visual display device, and having improved tactile user input capabilities.

According to a salient aspect, the disclosed systems and methods facilitate receiving tactile user inputs (e.g., user touches, button depressions etc.) on the exterior of the housing of the viewer and providing the user inputs to the touch sensitive display of the smartphone device that is within the viewer housing. In this manner, the disclosed systems and methods provide a viewer that is configured to be useable with a wide variety of smartphones without requiring input devices that require specifically placed magnetic sensors, wireless or dedicated cable connection to the electronic device 15.

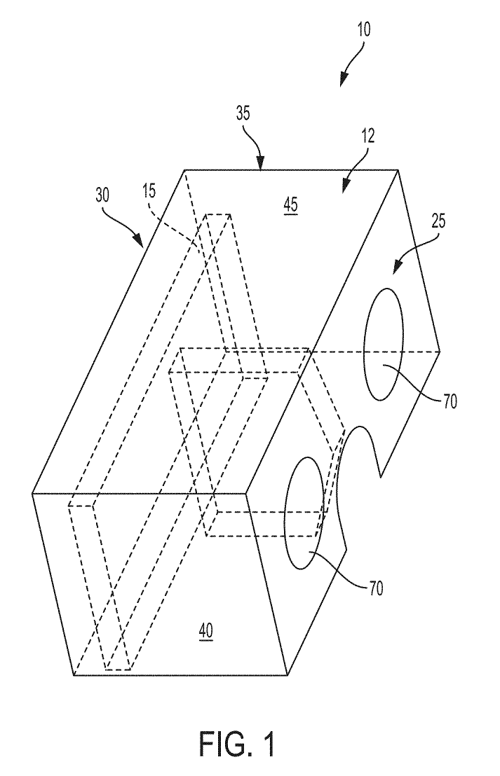

In one arrangement, the viewer is provided having a housing that encloses a generally hollow interior. As shown in FIG. 1, which is a perspective view of an exemplary viewer 10 having a conventional construction without an input mechanism. As shown, the viewer comprises a housing 12 that includes a front surface 30, back surface 25, top surface 45, bottom surface 50 (not shown), left surface 40 and right surface 35.

In some implementations, when in operation, housing 12 will be disposed in the position directly in front of the user's eyes such that the lenses contained in the housing, are in alignment with each of the user's eyes and the display of the electronic device is viewable through the lenses. It should be understood that the housing can be held by the user, or worn by the user such that the back surface of the housing is held against or in proximity to the user's face.

The housing 12 is configured to receive an electronic device 15 having a touch sensitive display. The electronic device 15 can be any electronic device configured to visually display information via a display (e.g., LED, Plasma, LCD display) and receive user inputs via a touch sensitive user interface (e.g., a capacitive touch sensitive display), as would be understood by those skilled in the art. For example and without limitation, electronic device 15 can include a smartphone or other such personal electronic device having a touch sensitive display, for example, an iPhone or Android smartphone device and the like that are commercially available.

Preferably the electronic device 15 is received or mounted within the interior of the housing 12 such that the electronic device display 17 is viewable when the user is looking through the housing 12. By way of further example, the electronic device 15, can be mounted on the housing such that it defines the back surface of the viewer. It can be appreciated that other configurations for the viewer 10 are envisioned without departing from the scope of the invention.

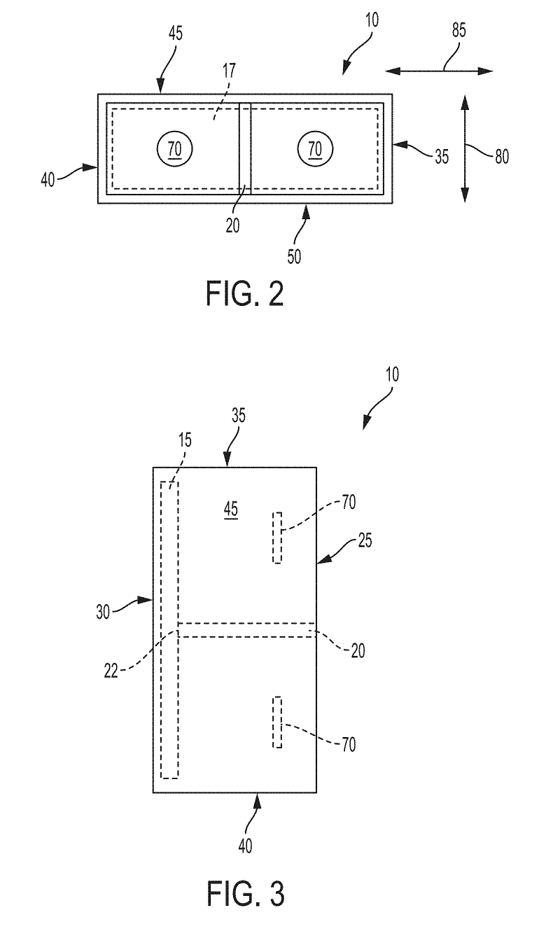

As shown in FIG. 2, which is a back view of the viewer (the terminology back side of refers to the side that the user looks into), preferably the housing 12 is configured to receive the electronic device 15 such that the touch sensitive display 17 of the device 15 is centered in a vertical direction 80 and/or a horizontal direction 85.

As shown in FIGS. 1 and 2, in some implementations, the housing includes one or more lenses 70 disposed therein arranged to be in alignment with the user's eyes when the user looks into the viewer. Generally, lenses 70 are mounted such that light from the display of the electronic device passes through lenses 70 to the user's eyes. The configuration, construction and placement of a lens or lenses 70 for use in virtual reality viewers are generally known and understood by those skilled in the art.

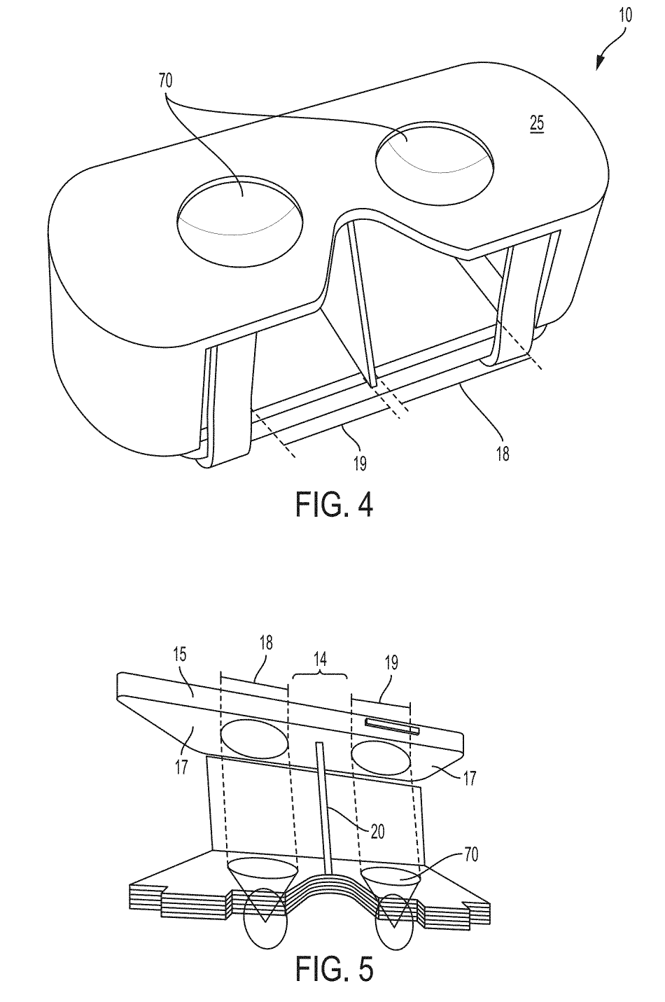

A view divider 20 can also be disposed within the housing. FIG. 4 is a perspective view of an exemplary configuration of a viewer 10 without a top, bottom and sides and showing the interior space of the viewer including the view divider 20. FIG. 5 shows a bottom view of the interior of an exemplary viewer 10 including view divider 20 and having the left and right, bottom and front sides removed. Referring to FIG. 5, the view divider 20 is configured to isolate the field of view of the left eye from the right eye. In other words, the view divider serves to obstruct the right eye from seeing or receiving images displayed by the left portion 19 of the display 17 of the electronic device 15 and the left eye from seeing images displayed by the right portion 18 of the display 17. It should also be appreciated that the particular width of the left and right portions of the display that are actually viewable by the user can vary depending on the lenses. In some implementations view dividers are not used.

Between the left and right portion of the display 17 is a central portion 14 of the display. The central portion of the display is not viewable by either the left or right eye due to the view divider 20, and, in addition or alternatively, due to the optical characteristics of the lenses 70. The width of the central portion 14 can range from the width of the view divider 20 but can be larger depending on the optical characteristics of the lenses 70. The central portion 14 that is not viewable by either the left or right eye can also vary in shape depending on the optical characteristics of the lenses. For example it might be rectangular or an hour glass shape that is wider towards the top and bottom sides of the viewer and narrower in the middle section of the display 17.

In one arrangement, the viewer 10 is configured to include one or more input devices that are configured to receive user inputs at the exterior of the viewer and provide such inputs directly to the touch sensitive display 17. The input devices can be configured to be passive and/or active input devices.

Preferably the inputs are provided to the display at the central portion 14 of the display, however one or more of the user inputs can be provided to the electronic device at alternative portions of the display 17 as well. Because the central portion 14 of the display is not viewable by the left or right eye to, by providing inputs at the central portion 14, the viewer 10 is capable of providing inputs to the electronic device 15 in a manner that does not disturb the field of view of the left or right eye. Moreover, because the device 15 is received within the housing and preferably positioned such that the display 17 portion of the device is generally centered in at least a horizontal direction and often in vertical direction as well, providing inputs in the central portion 14, for example, where the view divider 20 is proximate to the display 17, allows the systems and methods disclosed herein to be useable with a wide variety of touch sensitive smartphone devices of various sizes and screen layouts. Moreover software can be configured universally to these touch points regardless of the shape or size of the device because of the centered location.

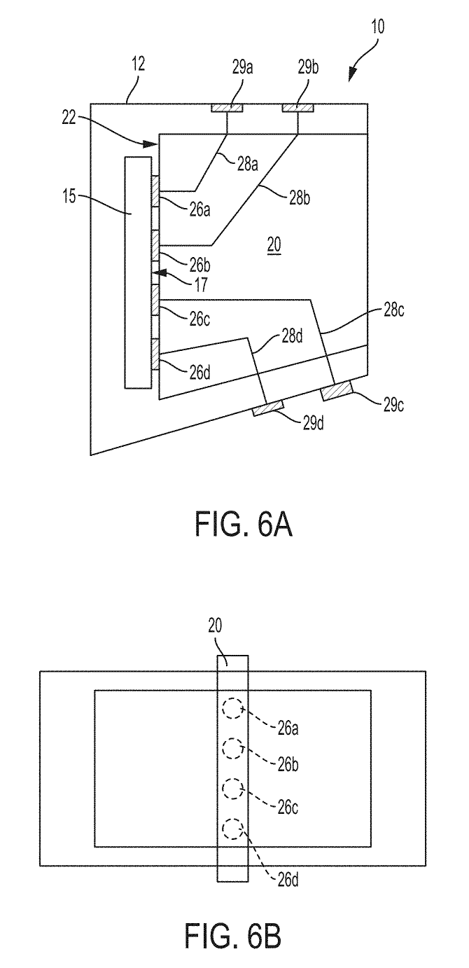

An exemplary implementation of a viewer including an input mechanism in accordance with an embodiment of the invention is shown in FIG. 6A-6B, which depict a cross-sectional view and of the exemplary viewer 10, including the view divider 20 and the electronic device 15 from the side and back perspective respectively. As shown, the viewer includes input devices that include one or more touchscreen inputs (26a-26d). In this particular exemplary configuration, the touchscreen inputs (26a-26d) are disposed on the distal surface 22 of the view divider 20. Preferably, the electronic device 15 is mounted in a manner such that the touch sensitive display 17 of the device 15, is proximate to (or is touching) at least a portion of the distal surface 22 of the view divider 20, such that the display 17 (not shown from this particular perspective) of the device is in physical contact with the surface of the touchscreen input portion of the input mechanism.

As most smartphones have capacitive touch sensitive displays, in an exemplary implementation, the touchscreen inputs (26a-26d) are constructed from a conductive material, for example, a conductive foam or polymer and the like as are used as the tip of a stylus configured for use with a capacitive touch screen. A compressible material will allow the housing to accommodate devices of varying thicknesses and create a capacitive connection between the display and the touchscreen inputs without the screen touching other portions of the surface 22, for example, to prevent scratching of the screen, provide communicative connection between touchscreen input and the touchscreen without cross-talk and other such considerations.

Preferably, the touchscreen inputs (26a-26d) are electrically coupled to one or more user inputs (29a-29d) that are configured to receive user interactions while using the viewer. Preferably the user inputs (29a-29d) are exposed on the outer surfaces of the housing or positioned on the exterior of the housing 12 such that the user can interact with the user inputs (29a-29d) while using the viewer I 0, although other configurations are envisioned without departing from the scope of the invention. The user inputs are configured to sense/detect or receive the user interactions and transmit/transfer/relay the user interaction to the touch sensitive display via the touch screen inputs (26a-26d). In some implementations, the user inputs relay the user interactions to the touch screen inputs (26a-26d) via input leads (28a-28d), respectively. For example and without limitation, input leads can be conductive wires/leads that electrically couple the user inputs (29a-29d) to touchscreen inputs (26a-26d).

In such an exemplary configuration in which the input device is a passive input device, the user inputs (e.g., 29a-29d) are preferably constructed of conductive material, for example, a metalized polymer, conductive polymers, conductive/capacitive inks, carbon based inks or other such inks designed to activate capacitive screens. Accordingly, a user touch of a conductive user input (e.g., 29a), via the conductive lead (e.g., 28a) and touchscreen input (e.g., 26a), will alter the electrical properties of the portion of the display 17 that is in contact with the touchscreen input.

As will be understood by those skilled in the art, the device 15 having a capacitive touch sensitive display 17 can detect the particular location of a change in the electrical property that is caused by the user touch of the user input (e.g., 29a). As would be understood by those skilled in the art, based on the particular location of the sensed change, the device 15, which has a processor executing instructions in the form of code, can interpret that an electrical change sensed at a particular location on the display 17 corresponds to a user interaction with a particular user input and corresponds to a prescribed input instruction, for example, a left mouse click or a right mouse click, or a double click, or as the user moving a cursor, or other such functions. Moreover, it would be understood that other combinations of user interactions sensed by the touch sensitive display can be interpreted as one or more of a number of user inputs such as pushing all 4 buttons at once could represent grabbing a virtual item. The 3 dimensional physical interaction offered by the users hands wrapping around the virtual reality viewer and interacting with the inputs can more easily be translated into 3 dimensional virtual interactions in a more natural way then previous user input mechanisms used today. It should also be understood that the arrangement of the touchscreen inputs the corresponding user inputs and associated functions can be pre-defined in software that is loaded into and executing in the device 15 processor.

Although an exemplary passive input device configuration having 4 distinct user inputs has been disclosed, it can be appreciated that other passive input device configurations are envisioned. For example, an array of user inputs and corresponding touchscreen inputs can be provided. It should also be understood that other active input device configurations can also be implemented in accordance with the disclosed embodiments without departing from the scope of the invention.

Although FIG. 6A shows the user inputs positioned on the top and bottom surfaces of the housing 12 and also shows that the leads run through the view divider 20 and through the top and bottom surfaces of the housing to corresponding user inputs, it can be appreciated that the leads can run through any portions of the housing. It can be further appreciated that any number of the user inputs (29a-29d) can be located on any portion of the housing and in any orientation or configuration. Moreover, it can be further appreciated that any number of touchscreen inputs (e.g., 26a-26d) can be located on the distal end 22 and in any orientation or configuration.

Moreover, although the exemplary configuration provides the user inputs to the screen 17 at the central portion 14 of the display 17 via the view divider 20, other configurations are possible. For example, the viewer can provide such touchscreen inputs (e.g., 26a-26d) on a surface that abuts one or more other portions the display 17.

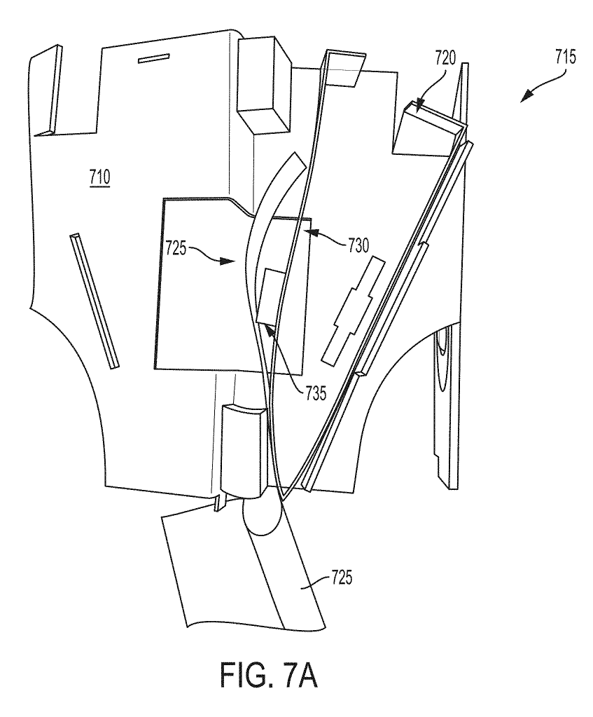

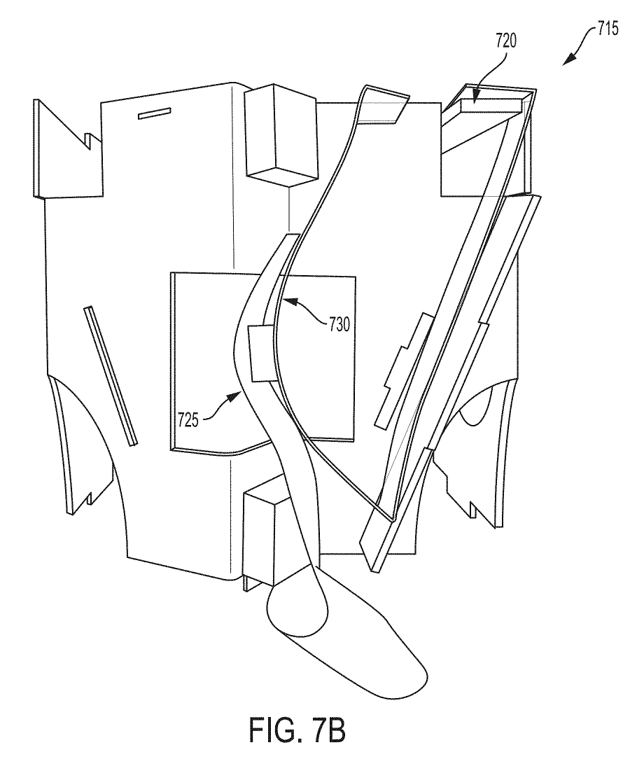

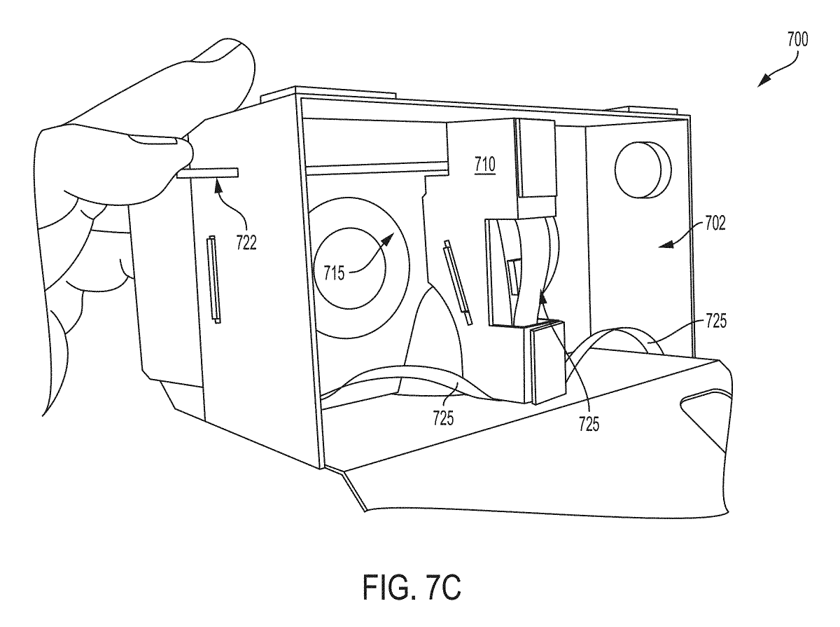

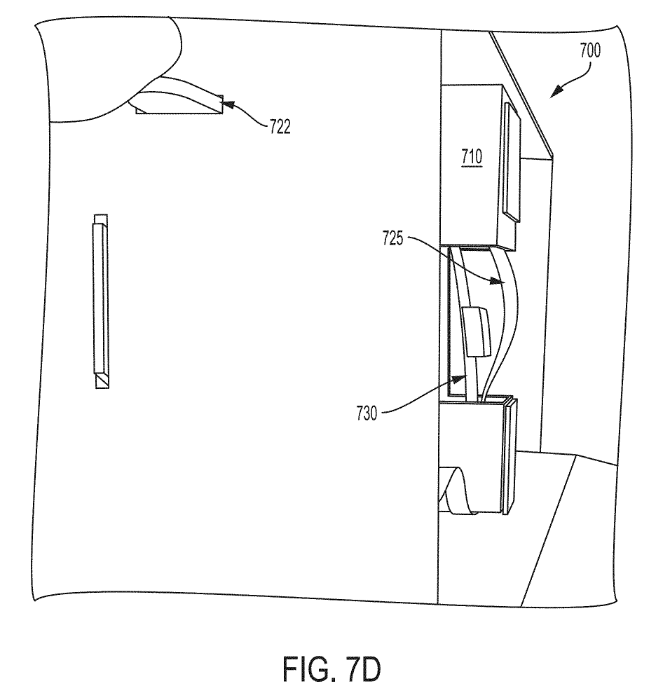

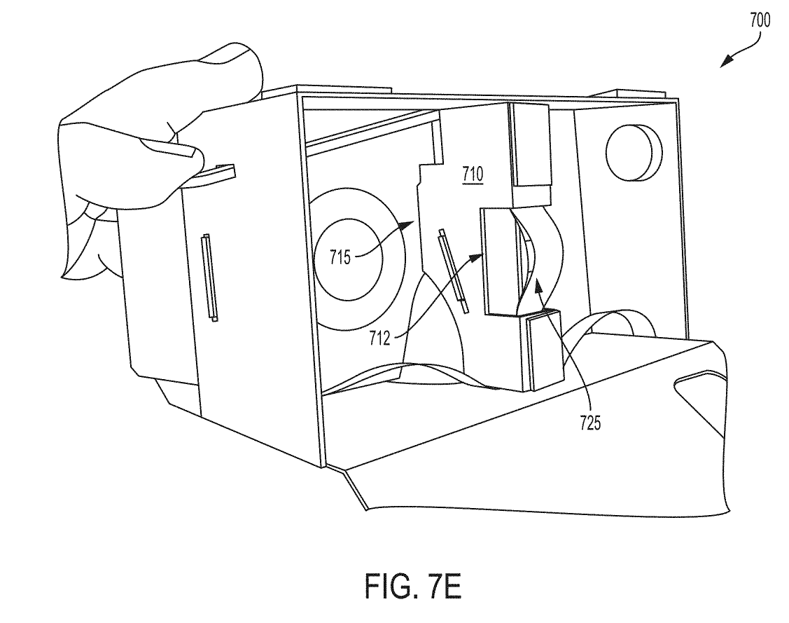

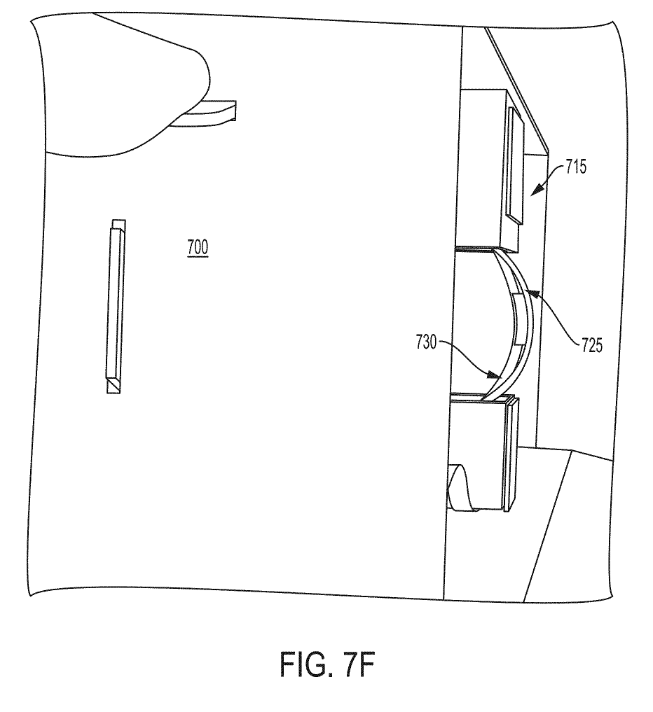

In accordance with the disclosed embodiments of the invention, the exemplary viewers can be configured to allow the user to mechanically induce an electrical/capacitive touch event on the touchscreen. Further to the foregoing exemplary embodiments of the invention, additional exemplary configurations of a viewer having an input mechanism, which is also referred to as the user input assembly, configured to induce a capacitive touch event that is detectable by a touchscreen based on mutual-capacitance are further described herein. It can be appreciated that the exemplary implementation described herein can be adapted to mechanically induce input events on a variety of types of touchscreens (e.g., resistive touchscreen events, touch events). Additional exemplary configurations of the viewer in accordance with the disclosed embodiments are further described herein in relation to FIGS. 7A-7F.

FIG. 7C depicts a perspective view of a viewer 700 assembled and having a front side open showing the generally hollow interior of the viewer. Also shown is an input mechanism 715. The input mechanism is disposed within the interior 702 of the housing of the viewer 700. Moreover, at least a portion of the input mechanism is also accessible from the exterior of the viewer such that a user can interact with the input mechanism and cause the portion of the input mechanism contained within the housing to generate a touch input on the touch interface. More specifically, the input mechanism is moveable within the interior between at least a first position (also referred to as an unactuated state), in which a portion of the input mechanism is retracted so as to not contact a touchscreen of the mobile device, and an extended position (also referred to as the actuated state) in which a surface of the input mechanism contacts the touch-screen of the mobile electronic. As shown, at least a portion of the input mechanism is centrally located within the housing and defines at least a portion of a view divider 710. It should be appreciated that the housing and or one or more portions of the input mechanism further described herein can be comprised of a variety of materials such as plastics, metals, composites, woods and other heavy paper-like materials (e.g., cardboard) and or other such natural and synthetic materials.

FIG. 7A depicts the view divider 710 with one side of the view divider folded back so as to expose a portion of the user input mechanism 715 disposed within the interior of the viewer 700. The diagram also shows the user input mechanism 715 in an unactuated state.

As shown, FIG. 7A depicts a distal end 720 of a user input portion of the user input mechanism, which in this exemplary implementation is a lever. The proximal end (not shown) of the lever is accessible to a user from outside the viewer when assembled. The diagram depicts the input assembly 715 in an un-actuated state. Also shown is an electrical shield 725. The electric shield is arranged such that at least a portion of the electric shield is configured to contact the touch-screen of the mobile electronic device when the input mechanism is in the extended position. The electrical shield is a material configured to, when brought in proximity to and/or touches the touchscreen, induce a touch event that is electrically detectable by the touchscreen/device. In some implementations the electrical shield material can be a metallized textile/fabric or films, e.g., polymer film coated with a thin layer of metal, for example PET (Polyethylene terephthalate) films and Mylar (BoPET Biaxially-oriented polyethylene terephthalate). Such metalized materials are commonly used in anti-static bags. Moreover, the electrical shield can be comprised of other metallic conductors, non-metallic conductors, metallized fabrics, metallized polymers, conductive polymers, conductive fabrics, flexographic inks, rigid flex printed circuit board (PCB) and the like. As would be understood by those skilled in the art, such materials have electrical properties that, when a surface of the material is brought in proximity to a touchscreen and/or touches a touchscreen, can affect the electrical properties detected at that location by the touchscreen device. Other materials having the requisite electrical properties can also be used, for example, inks or pastes with carbon such as black flexographic inks having capacitive touch properties that are printed on substrates. Moreover, it can be appreciated that a combination of materials can be used to provide a surface of the input mechanism that is configured to induce a detectable touch input when the surface is touched to the touchscreen. For example, the electric shield can include a conductive polymer arranged to selectively contact the touchscreen and that is electrically coupled to a metallized fabric or conductive ink applied to a surface of the housing and/or input mechanism.

In some implementations, the electric shield is configured (e.g., sized and/or positioned) so as to have capacitive properties sufficient to be detected by a capacitive touch-screen when the input mechanism is in the extended position and in the absence of human contact with the electric shield. However, it can also be appreciated that, in some implementations, the electric shield can be electrically coupled to the portion of the input mechanism that is interacted with by the user such that electrical properties of the user's body can be utilized to induce the touch input.

Also shown is a coupling 730 that is configured to move the input mechanism towards the touchscreen when the lever is actuated. The coupling is a linkage that couples the portion of the input mechanism that is accessible to the user from the exterior (e.g., the proximal end of the lever) to the surface of the input mechanism configured to touch the touchscreen and induce a touch input. The coupling mechanically translates user actuation of the portion of the input mechanism from the exterior of the housing into movement of the input mechanism within the interior of the housing and causing a surface of the input mechanism to touch the touchscreen. For example, in the particular implementation shown in FIGS. 7A-7F, actuation of the lever causes the coupling to deform and extend in a direction towards the touchscreen, which in turn moves a portion of the electrical shield towards the touchscreen. Furthermore, as shown in FIG. 7A, the coupling can be coupled to the housing. As can be appreciated, coupling one or more portions of the input mechanism to the housing can serve to support the input mechanism as well as guide the movement of the input mechanism during user actuation.

The coupling can be comprised of one or more flexible materials such as plastics, metals, composites, woods and other heavy paper-like materials (e.g., cardboard) and or other such natural and synthetic materials. A linkage or coupling that is flexible can be beneficial in that the material memory causes the coupling to return to a resting state when pressure is released from the lever which automatically pulls the input mechanism away from the touchscreen. However, alternative methods for automatically retracting the contact surface of the input mechanism can be similarly implemented without departing from the scope of the invention.

Although a particular exemplary linkage configuration is described in relation to FIGS. 7A-7F, it can be appreciated that other linkage configurations can be implemented without departing from the scope of the invention. It can also be appreciated that, although the lever, coupling and metallic shield have been described as individual components, the subject invention is not so limited as one or more of the foregoing components can be joined or integrally formed as single unit. Similarly, it can also be appreciated that one or more of the components of the input mechanism can be joined to the housing or integrally formed with the housing m a permanent or temporary fashion using any conventional manufacturing techniques.

In some implementations, a compressible pad 735, for example, a foam or foam-like material can be disposed between the flexible coupling and the electric shield. The pad can be placed between the flexible coupling and the electrical shield 725 in at least the location where the coupling contacts the metallic shield when extended (e.g., the back side of the electrical shield where the front side of the shield material contacts the touchscreen when extended). It can be appreciated that the electrical shield can be attached to the foam material or unattached. It can also be appreciated that the pad can be coupled to the coupling either directly or indirectly by one or more intermediate structures that comprise the input mechanism. The pad is used to create a sufficiently sized contact surface between the front side of the shield material and the touchscreen so as to register a touch input event on the screen (e.g., to simulate the size and shape of a finger). The pad also helps the surface of the input mechanism configured to touch the touchscreen (i.e., the shield material) conform to the touchscreen surface when the input mechanism is in the extended position/actuated state.

It can be appreciated that various sizes and shapes of the pad can be used to induce a sufficient sized contact surface. It can also be appreciated that in some implementations the pad can be omitted. It can also be appreciated that the metallic shield and pad may be integrated or combined into a single material such as conductive foam gaskets used in Electromagnetic Interference (EMI) or Radio Frequency Interference (RFI) applications. It can also be appreciated that the pad can be sized and/or shaped such that actuating the input mechanism with greater force causes a greater surface area of the electrical shield to be applied to the screen which can be interpreted differently by the device than when a smaller surface area is detected by the touchscreen. This input mechanism configuration can be used to provide a secondary signal for detecting the amplitude of the users input, for example a method for detecting the amount of force the user applied to the input.

A portion of the lever can be attached to or in communication with (i.e., touching) or integrally formed to at least a portion of the coupling. For instance, as shown, the distal end of the lever can be abutting a portion of the coupling such that, when the lever is actuated at a proximal end, movement of the distal end of the lever causes the plastic coupling to buckle and at least a portion of the coupling extends in the direction towards the touchscreen. In addition or alternatively the coupling can be a structure that is flexibly coupled to one or more portions of the housing such that it moves in a prescribed manner when a lever is moved or a button is pushed by the user.

FIG. 7A depicts the view divider 710 with one side of the view divider folded back so as to expose the user input assembly 715 disposed within the view divider of the viewer 700. The diagram also shows the user input assembly 715 in an unactuated state.

FIG. 7B depicts the view divider 710 with one side of the view divider folded back so as to expose the user input assembly 715 disposed within the view divider of the viewer 700. The diagram also shows the user input assembly 715 in an actuated state.

FIG. 7C depicts a perspective view of the viewer 700 assembled and showing the view divider 710 and showing at least a portion of the user input assembly 715 disposed within the interior of the housing 700. The diagram also shows the user input assembly 715 in an un-actuated state. As shown, the user input (lever) includes a proximal end portion 722 that extends through a cut-out in the housing of the viewer 700 and is accordingly accessible to the user from the exterior of the housing. It can be appreciated that alternative configurations in which one or more portions of the lever or other such mechanical actuators or portions of the input mechanism is accessible from the exterior of the viewer are envisioned. For instance the lever can be contained within the interior of the housing and accessible to the user through a cut-out through an external wall of the housing.

FIG. 7D depicts a side view of the viewer 700 assembled and showing the view divider 710 and showing at least a portion of the user input assembly 715 disposed within the interior of the viewer housing 700. The figure also shows the user input assembly 715 in an un-actuated state.

FIG. 7E depicts a perspective view of the viewer 700 assembled and showing the view divider 710 and showing at least a portion of the user input assembly 715 disposed within the interior of the viewer housing 700. The diagram also shows the user input assembly 715 in an actuated state where the electrical shield is extended out of the cut-out in the view divider.

FIG. 7F depicts a side view of the viewer 700 assembled and showing the view divider 710 and showing at least a portion of the user input assembly 715 disposed within the interior of the viewer 700. The diagram also shows the user input assembly 715 in an actuated state where the electrical shield is extended out of the cut-out 712 in the view divider.

When a user device is placed within the viewer, such that the touchscreen is facing the interior of the viewer and near the view divider, actuating the user input assembly by actuating the lever can cause the coupling to flex and therefore cause the electrical shield to extend towards and touch the touchscreen of the user device. In this exemplary implementation, the coupling and shield extend out of a cut-out in the view divider. As a result, the device can detect the change in an electrical property at one or more locations of the screen, which is caused by the electrical shield touching (or approaching) the touch-sensitive display.

Accordingly, it can be appreciated that, what is provided is a virtual reality viewer for use with an electronic touchscreen device comprising a housing for receiving and holding a touchscreen display device within an interior region of the housing. The viewer further comprising an input mechanism that is accessible from an exterior of the housing and is moveable within the interior between at least a first position and an extended position, wherein a surface of the input mechanism is configured to contact the touch-screen of the mobile electronic device when in the extended position. In one particular implementation, the input mechanism comprises a lever having a proximal end that is exposed to the exterior of the housing and a distal end disposed within the housing, whereby the proximal end of the lever is accessible by a user from the exterior of the housing and actuation (e.g., movement) of the lever at the proximal end translates to mechanical movement of the distal end. The viewer further comprising a coupling attached to or in communication with the distal end of the lever such that, when the lever is actuated at the proximal end, movement of the lever causes at least a portion of the coupling to move toward a back wall of the housing, e.g., extend or move in a direction of the touchscreen. The viewer further comprises an electrical shield, wherein the electrical shield is a material configured to induce a touch event that is electrically detectable by a touchscreen/device when at least a portion of the shield contacts or is in proximity to a touchscreen. In addition, the portion of the electrical shield is positioned between the coupling and the touchscreen such that movement of the coupling advances at least the portion of the electrical shield material toward the touchscreen so as to induce the touch event. Moreover, the viewer can further comprise a compressible pad disposed between the portion of the coupling and the electrical shield, wherein the pad is attached to the coupling and is sized, shaped and has the softness/rigidness to create a sufficiently sized contact point for generating a touchscreen detection event on the touchscreen device. The compressible pad and electrical shield material work to mimic the electrical and physical properties of a human finger so that any form of touch screen technology will register a touch event when the lever mechanism is actuated. As would be understood by those skilled in the art the combination of physical, and electrical properties of this pad electrical shield material can be tuned to work on a variety of touch screen technologies such as capacitive, resistive, or conductive touch screen technologies. As previously noted, in some implementations, one or more components of the exemplary user input assembly can be integrated into or part of the view divider.

According to a salient aspect, the viewer and the exemplary electro-mechanical user input assembly is configured to allow a user to interact with the touch sensitive screen without access to the touch sensitive screen while within the viewer. Moreover, the exemplary viewer and user input assembly can be configured to allow a user to interact with the touch sensitive screen without reliance on the electrical properties of the human body to induce the electrical event. For instance, the metallized film 725 can be sized such that it is suitable for inducing a touch event without requiring user contact therewith. In addition or alternatively, the portion of the metallized film that is configured to touch the screen can be accessible to receiving a user touch. For instance, a portion of the metallized film can be exposed on the lever 722 or otherwise accessible to the user on an external surface.

As would be understood by those skilled in the art, the mobile electronic device, which has a processor executing instructions in the form of code, can detect that electrical property change at the one or more locations and interpret the change as one or more prescribed user interactions. In some implementations, the user interaction can be interpreted as a simple click event. In some implementations, a variety of possible user interactions can be detected as a function of the location of the touch event on the touchscreen (e.g., as caused by different input mechanisms configured to cause touch inputs at respective locations on the touchscreen), the duration of the touch event, the size of the area of the touchscreen registering the touch event, and the like. These detected aspects of the touch event can be interpreted and translated into one or more prescribed input instructions, for example, a left mouse click or a right mouse click, a double click, or as the user moving a cursor, a virtual gesture such as a grab, push, pull, throw, pinch or as a scaled input instruction such as a hold softly or hold firmly or other such functions.

Moreover, user interactions detected by the touch sensitive display can be interpreted in combination with one or more other input devices. More specifically, a user interaction detected can be interpreted in light of other input data received by the user device from other on-board input devices or data sources, for example and without limitation, an accelerometer that detects the orientation and location of the device or a camera or 3d scanner that detects the physical environment of the user or portions of the user's body position. In addition, the housing can also include one or more additional user input devices electrically coupled to the mobile device by a wireless or wired connection, such that inputs via the electro-mechanical input mechanism can be provided to the mobile device in addition to inputs provided using the additional input device. For example, based on the orientation and location of the device and the information being viewed by the user on the device, the device can determine that a user is looking at an interactive virtual icon using the viewer. Paired with the user actuation of the user input mechanism and the detection of a touch input, the device can interpret the combined user input (e.g. accelerometer data and the touch interaction data) as a “mouse click” on that particular virtual icon or as a grab or hold of that virtual item or icon. Another example might be combining the accelerometer data for device position, camera data from the device capturing the user's physical environment, and a touch event from the mechanism described in this invention in a way that allows the user to select a real physical item to scan/import into a virtual or augmented reality interface allowing for the digital manipulation of the physical item or overlaying additional information about the physical item.

It can also be appreciated that the user input mechanism can be adapted to induce user interactions at a variety of different locations or multiple user input assemblies can be provided to facilitate more complex user inputs.

In another exemplary arrangement, a foldable viewer is provided that is configured to be transitioned from a first, collapsed and flat-packed state, to an expanded operative state. For instance such viewers can be arranged as further described herein to facilitate ease of final assembly for end users as well as providing a viewer that can be transitioned back to a collapsed and flat-packable state. The general shape and configuration, when in the operative state, is similar to the exemplary viewers described in relation to FIGS. 1-7F. It should be appreciated that the housing further described herein can be constructed from a variety of materials such as plastics, metals, composites, woods and other heavy paper-like materials (e.g., cardboard) and or other such natural and synthetic sheet-like materials suitable for providing a foldable and durable viewer. Preferably the viewer is constructed from a continuous sheet of material that can be cut to define the various walls of the housing that are interconnected. As further described herein, the walls of the housing are defined by cutting (e.g., using a die or other cutting tool such as a laser) the outside edges and scoring or defining fold lines and/or perforations where two adjacent walls meet (e.g., joints) such that the walls are joined yet the joint can flex from the fold lines and thus the viewer can be folded together and assembled into the shape of the viewer. In this exemplary implementation, cardboard is a suitable material for constructing the foldable viewer due to its cost, sufficient rigidity when in a folded state and when in the operative state and being used. Cardboard is also beneficial for its ability to be relatively easily cut and scored to define fold lines, perforations, tabs and corresponding slots such that the various walls can be precisely assembled (e.g., walls folded and interlocked) and maintain sufficient rigidity and durability and shape when expanded into the operative state.

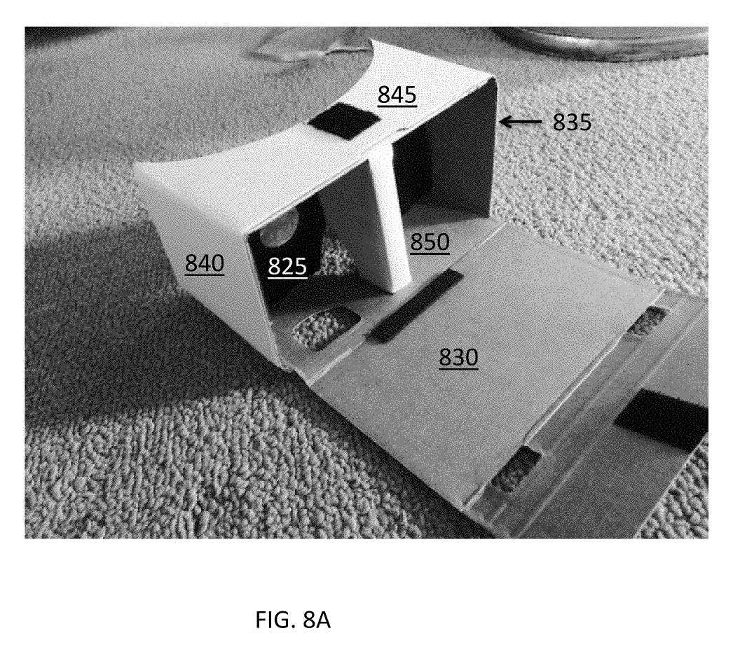

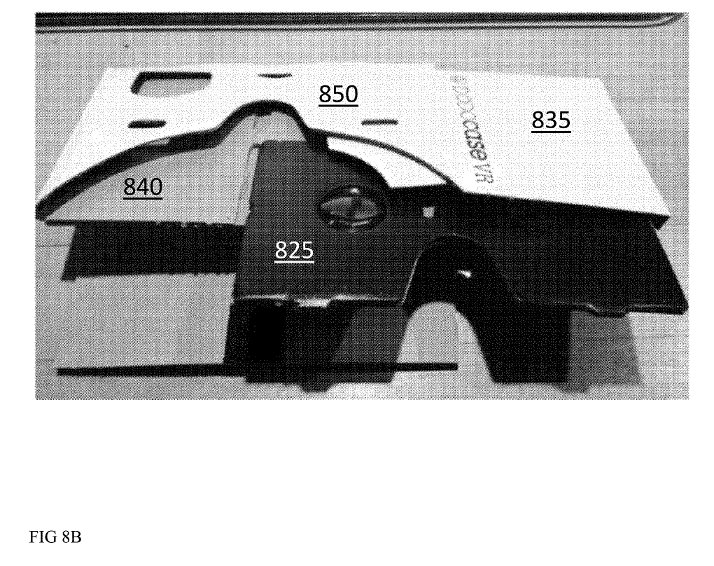

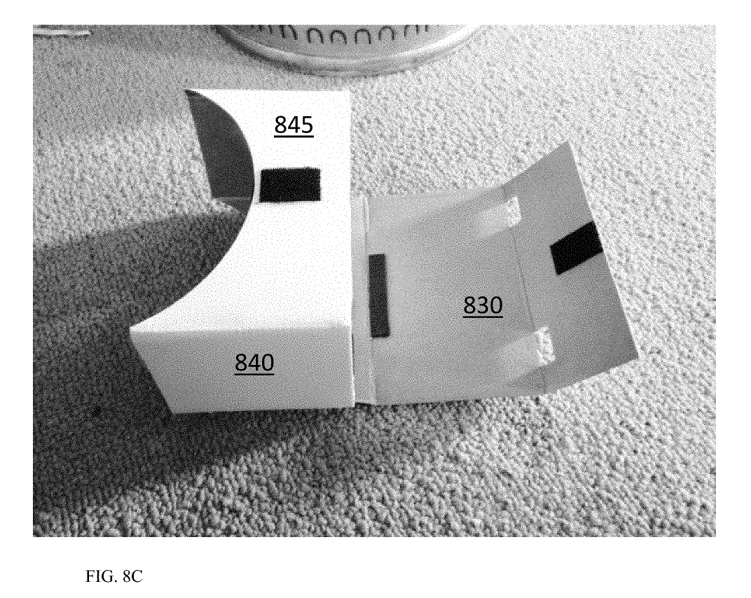

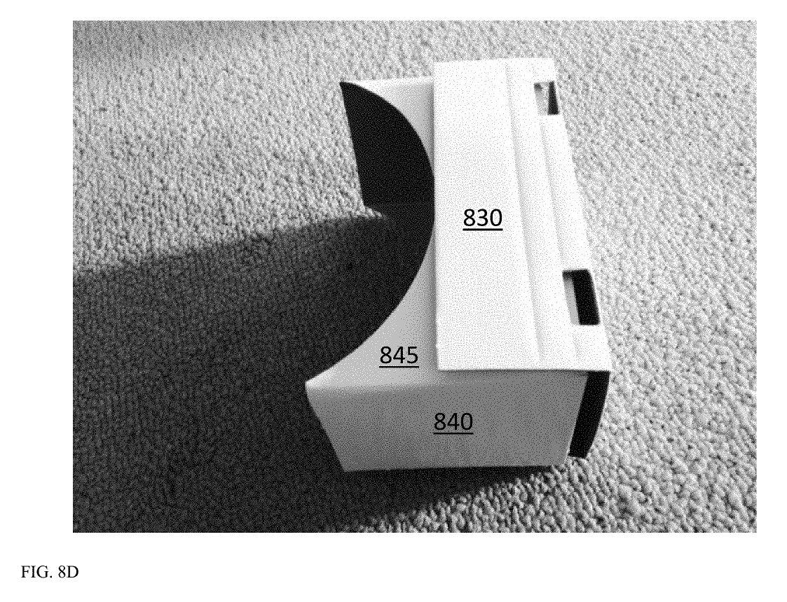

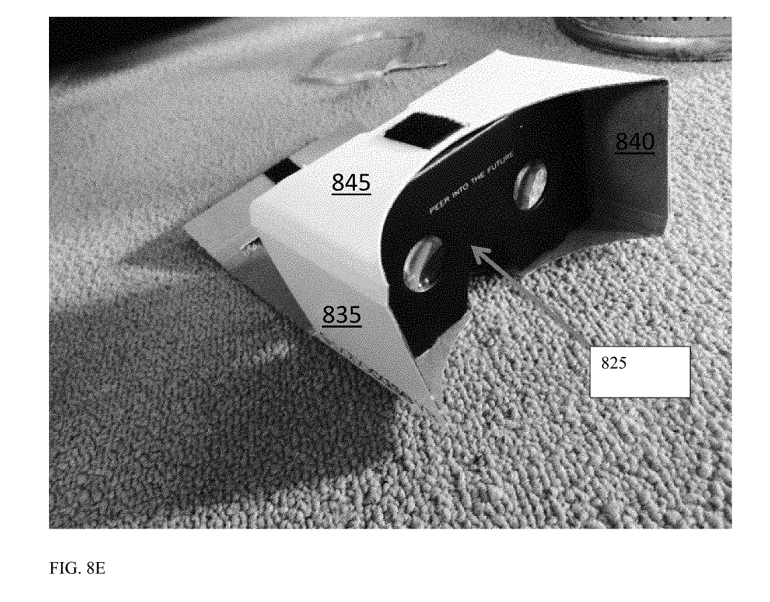

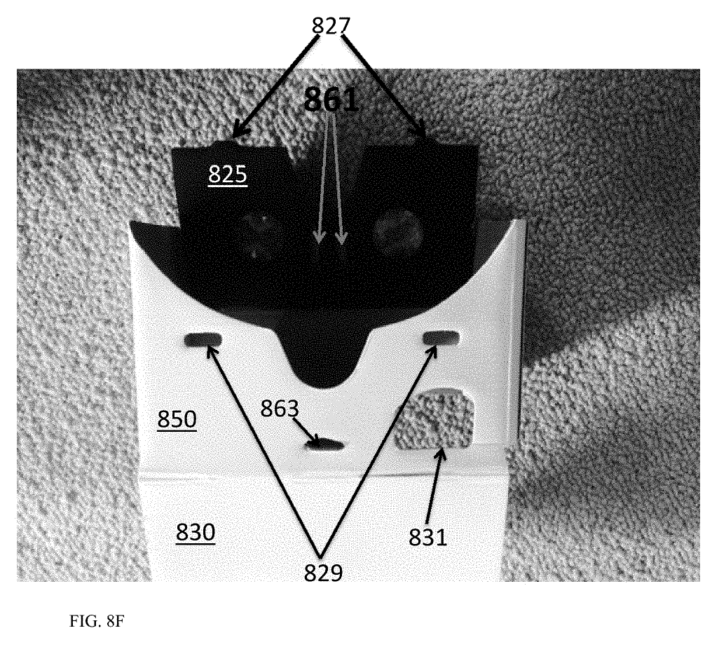

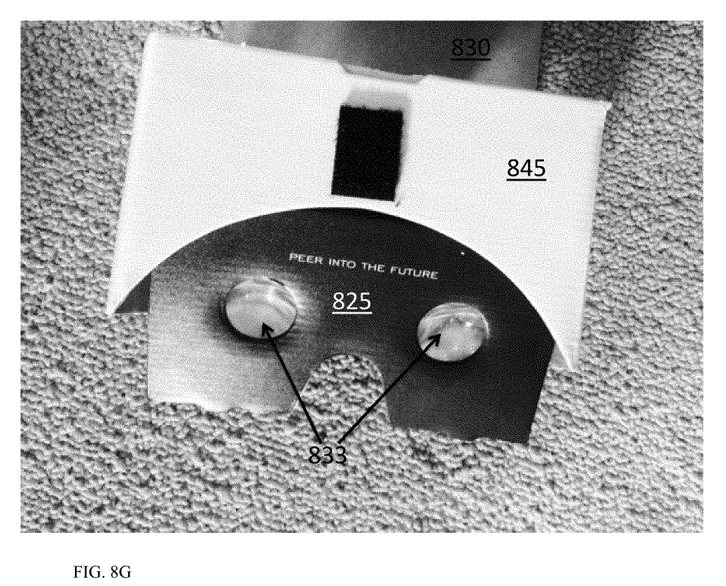

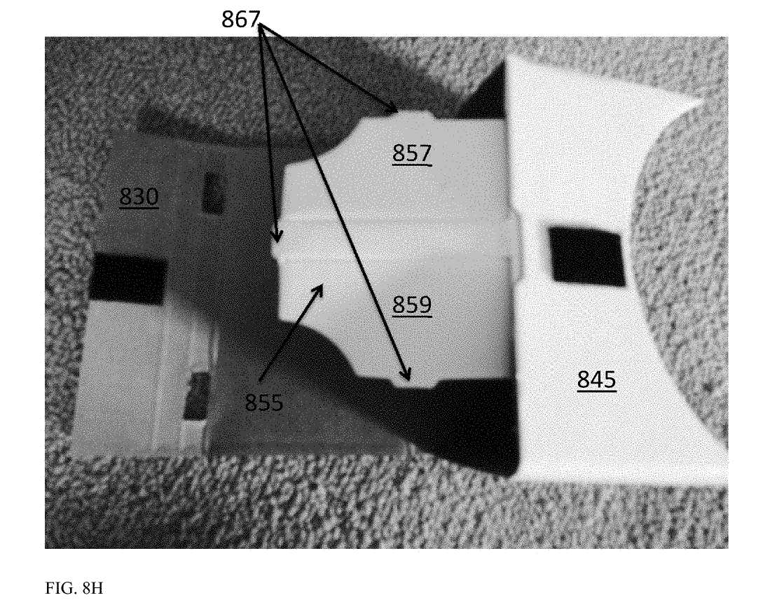

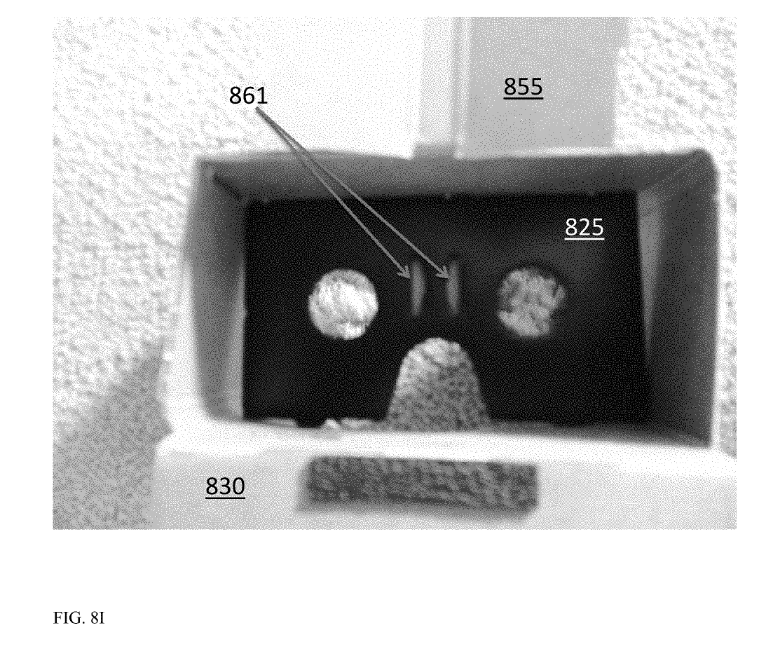

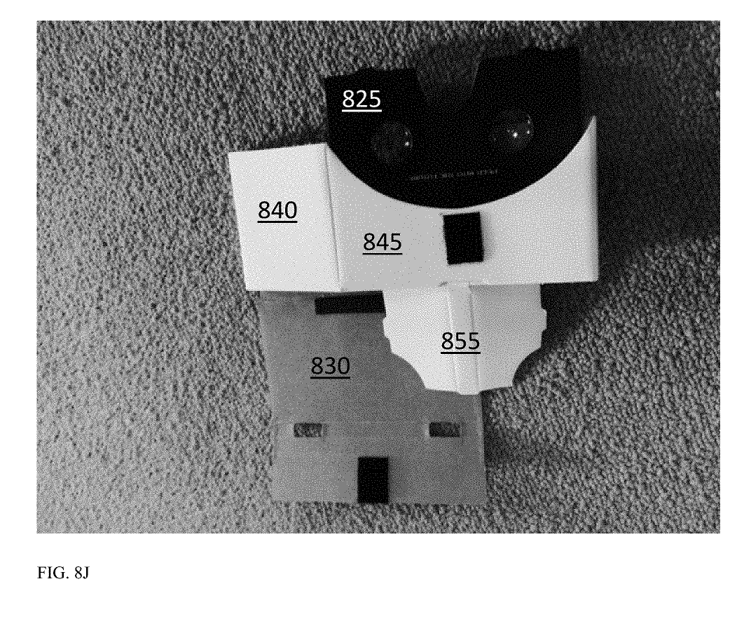

FIG. 8B is a bottom view of the viewer in the collapsed and flat-packable state prior to transitioning into the operative state. The viewer will be further shown and described in relation to various stages of transitioning the viewer from the flat packed state as shown in FIG. 8B to the operative state as shown in FIG. 8A.

The exemplary viewer includes a housing that, when in an operative (e.g., expanded state) encloses a generally hollow interior. FIG. 8A, is a front perspective view of an exemplary viewer 800 in the operative state, wherein the operative state is when the viewer is in the assembled and folded condition and is ready to receive a mobile device for use.

As shown, the viewer 800 comprises a housing 812 with a main body portion that includes a top wall 845, bottom wall 850 (opposite the top wall, not shown), left wall 840 and right wall 835 (opposite the left wall). Accordingly, the main body of the viewer is a substantially rectangular box, however the shape of the box and walls thereof (e.g., top and bottom wall) can be contoured to better fit a user's face as the user looks into the viewer, as shown in the following top perspective view picture of the viewer.

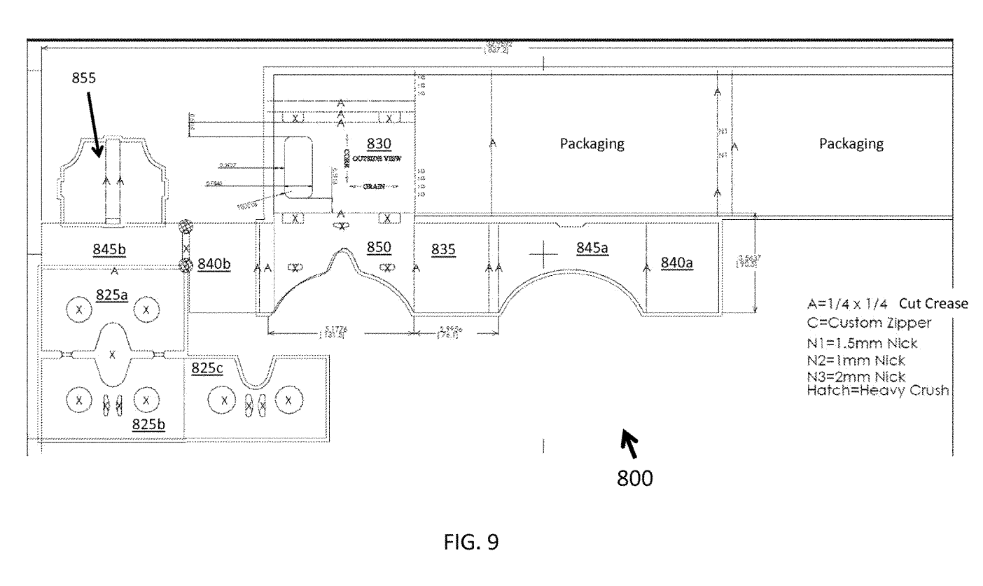

At least the main body is defined by a single, elongate section of material wherein at least the ends thereof are joined together (e.g., by glue or other permanent or temporary joining means) and the intersection between the walls are defined by one or more fold lines at each intersection. FIG. 9 is an exemplary dieline schematic (e.g., showing cuts, creases, nicks, crush/folds, holes, perforations) for manufacturing the viewer from a sheet of cardboard and including the integral outer flat-pack packaging. Moreover, various components of the viewer 800 described herein are also labeled on FIG. 9 for clarity. In regard to walls described in relation to FIGS. 8A-8J that are defined by multiple layers of cardboard material (e.g., overlapped and glued or otherwise abutting) those segments are identified in FIG. 9 by the corresponding number from FIG. 8 plus a notation “a” “b” “c” etc. For instance top wall 845 is defined by layers 845a and 845b as shown in FIG. 9. In addition, as shown in FIG. 9, holes that are cut in the sheet are marked with an “X,” and the legend further explains the particular construction of the viewer. A person of ordinary skill in the art would readily appreciate the exemplary construction and manufacturing process for the exemplary viewer based on the dieline/engineering drawing of FIG. 9.

Referring to FIG. 9, which shows the dieline of an unfolded and unassembled viewer, the viewer body comprises a substrate, for example, in the form of a cardboard sheet, cut according to the profile shown and having fold lines marked “A” in between adjacent walls of the viewer. The fold lines define boundaries of respective panels of the viewer. A series of first panels (e.g., 845b, 840b, 850, 835, 845a and 840a are disposed adjacent another panel in the series and is separated from a next panel by one of the fold lines or cuts/creases. The series of first panels are foldable along the fold lines along a common, parallel direction to define a hollow central cavity for the main body of the viewer 800. One or more of the panels in the series can be overlapped and joined (e.g., panels 845a and 845b can be overlapped and 840a and 840b can be similarly overlapped) and joined to complete the main body structure of the viewer.

The bond can be adhesive (or thermal in the case of a plastic substrate) or other suitable temporary or permanent joining means so as to connect those panels and secure the main portion of body in its intended shape. The bonds preferably comprise an adhesive; however, the bond can comprise other generally permanent connections as understood by those skilled in the art.

Preferably, the bond is “permanent” in that it is of such character that it is not readily opened by a consumer, and yet is sufficiently strong to permit the body to be collapsed laterally.

Accordingly, the panels of the first series can be folded along fold lines to define the rectangular body having an interior cavity and to permit the viewer body to be transitioned back into a flat condition.

As shown in FIG. 9, front wall 830 extends from the top wall 850 and foldable along a fold line “A” at the intersection of the front and top wall. In the exemplary embodiment, face plate 825 is defined by three panels 825a-825c and extends from panel 845b, which, along with panel 245a, defines top wall 845.

According to a salient aspect, the particular configuration in which the viewer body is defined by a continuous substrate (e.g., panels 845b, 840b, 850, 835, 845a and 840a as shown in FIG. 9). The faceplate 825 can constructed from the same or a separate substrate that is later attached to an interior surface of the body. This facilitates a manufacturers ability to more easily and conveniently embellish the outer surfaces of the viewer or manufacture and assemble components separately. Moreover, manufacturing the body from a continuous substrate joined using one bonding area (as opposed to many bonds) promotes the structural integrity of the exterior walls of the viewer.

Returning to FIG. 8A, a front wall 830 extends from a segment of the elongate section and in particular, the bottom wall. The bottom wall and the front wall are defined by the same piece of material and a joint is defined between the bottom wall and the front wall by one or more score lines/folds and/or perforations that promote flexibility of the joint. As shown in FIG. 8A, in one implementation, the joint is not flush with the intersection of the bottom wall and left/right sidewalls, rather it is set away from that intersection such that a phone placed into the housing can rest on the protruding portion of the bottom wall and extend beyond the sidewalls in the event that the phone is larger than the cross-sectional area of the housing interior. Preferably the front wall 830 is taller than the height of the sidewalls such that it can be folded over and attached to the top wall using non-permanent attachment mechanism such as a hook and loop attachment or snap or tab and complementary hole joining mechanism. The fold that allows the distal end of the front wall to fold over and be attached to the top wall can be defined by one or more folds or scoring lines and or holes/perforations. The front wall is shown in an opened and a closed/assembled state in FIGS. 8C and 8D, respectively, which are both side perspective views of the exemplary viewer in accordance with one or more of the disclosed embodiments.

As shown in FIG. 8C depicting the viewer 800 with the front wall open, one or more friction pads can be adhered to the inside surface of the front wall 830 to prevent the device from moving laterally and slipping out the opening defined by the ends of the front and sidewalls. As shown an inner surface of front wall 830 can include a joining mechanism disposed thereon (e.g., a piece of hook- and loop) that is configured to engage a complementary joining mechanism (e.g., two complementary sections of hook and loop fabric, not shown) that is disposed on an outside surface of the top wall (i.e., 845). Preferably, the joining mechanism is “temporary” in that it is of such character that the securement can be readily opened by a user, and yet is sufficiently strong to aid in maintaining the body in generally rigid shape when in the operative condition and/or to securely hold a mobile device in position when in use with the viewer. Other temporary securing mechanisms can be implemented without departing from the scope of the invention.

The exemplary viewer 800 also includes a back wall/face-plate 825. As shown in FIG. 8E, the back wall 825 is inset within the interior bounded by the top, bottom and sidewalls and front wall. At least a portion of the back wall can be defined by the same piece of material that defines the top/bottom, and sidewalls. As shown, the at least a portion can extend from the portion of the material defining the top wall. The intersection between the back wall portion and the top wall can be defined by a fold such that the back wall can be flexibly and securely coupled to a wall defining the main body of the viewer.

The back wall can comprise multiple layers of material folded onto one another, or can include one or more separate pieces of material that attached to define a multi-layer back wall. For example, at least a portion of the back wall portion can be a separate piece of cardboard that can be assembled to include lenses and then attached to the top wall, e.g., to a portion of the back wall that folds down from the top wall, say, during an initial assembly process. Accordingly, assembly of the lens and faceplate (e.g., back wall 825) can be performed separately and prior to final assembly and, because the lenses and main faceplate is then attached (e.g., using glue or other adhesive or other permanent or temporary joining means) to the top wall, the foldable viewer has sufficient structural integrity for repeated assembling into the operative state for use and then disassembling to return the device into a collapsed state. Although in some implementations, the back wall can be formed from multiple pieces, at least one of which is integrally formed with the main body of the viewer housing, it can be appreciated that the entire back wall can be integral to the remainder of the housing (i.e., one piece) or a separate unit that is attached to the body of the viewer 800. It can also be appreciated that although the back wall is shown as extending from the top wall it can similarly extend from the bottom wall without departing from the scope of the invention. The same can be said for the other pieces like the view divider 855 as further described herein.

As shown in FIGS. 8F and 8G, which are bottom and top views of the viewer 800 during transition into an operative state wherein the face-plate/back wall 825 is not folded into position, the back wall 825 can include one or more tabs (827) configured to engage complementary slots 829 formed in the bottom wall 850. Accordingly, the back wall/face-plate firmly and securely engages the bottom wall and causes the rectangular housing to take the intended shape for use and provides structural integrity but can also be disengaged and returned to the collapsed state as shown in the FIGS. 8B and 8J. In order to facilitate transitioning the device between a flat packed state into an operative state, the main portion of the body is a continuous structure (e.g., the top, bottom, left and right walls are integral and/or attached to define a continuous sequence of panels/walls) and the faceplate attached therein to an interior surface of the body (e.g., top wall 845). Accordingly, the shape of the faceplate 825 and the corresponding shape/folds of the body configure the body to expand from its collapsed state to the uncollapsed/operative state by pivoting the face-plate down into its operative position m which the tabs 827 engage complementary slots 829 and the faceplate is generally perpendicular to the top, bottom and sidewalls of the viewer.

FIG. 8F is a bottom view of the viewer 800 prior to folding the back wall/face-plate 825 down and into place such that the two tabs 827 of the back wall engage the complementary slots 829 formed in the bottom wall 850. Also shown is a hole 831 formed in the bottom wall such that a user can access the touch-screen of the smartphone with a finger.

FIG. 8G is a top-view of the viewer 800 prior to folding the back wall 825 into the interior region. As shown in FIG. 8G, the back wall includes one or more lenses 833 disposed therein arranged to be in alignment with the user's eyes when the user looks into the interior of the viewer.

The viewer can also include a view divider 855. The view divider can extend down from the top wall 845 and can be integral to the main body of the viewer or a separate component attached to a wall defining the main body.

FIG. 8H illustrates the viewer 800 in a state having the back wall folded down such that the main portion of the housing is in the un-collapsed state and shows the view divider 855 extended, i.e., prior to folding the side wings (857 and 859) in a direction towards one another and folding the view divider into the interior such that the tabs (867) engage complementary slots (861) formed in the back wall 825 and a complementary slot (863) formed in the bottom wall 850 to hold the view divider in place. The FIG. 8I, which is a front view of the viewer 800 prior to transitioning the view divider 855 into place, shows the complementary slots of the back wall, lenses and friction pad on the front wall.

FIG. 8J is a top view of the viewer 800 in a collapsed and unfolded state in accordance with an embodiment of the invention.

It is to be understood that like numerals in the drawings represent like elements through the several figures, and that not all components and/or steps described and illustrated with reference to the figures are required for all embodiments or arrangements.

The subject matter described above is provided by way of illustration only and should not be construed as limiting. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, as set forth in each and any of the following claims.

1. (canceled)

2. A foldable virtual reality viewer comprising:
a housing including a top wall, a bottom wall, a first side wall, and a second side wall, wherein the housing has a collapsed state and an operative state.

3. The foldable virtual reality viewer of claim 2, wherein the housing is formed from a sheet of material.

4. The foldable virtual reality viewer of claim 3, wherein a first end of the cut out and a second end of the cut out are joined together by temporary or permanent joining means,

5. The foldable virtual reality viewer of claim 2, wherein the top wall and the bottom wall are contoured for a user's face.

6. The foldable virtual reality viewer of claim 2, wherein the collapsed state is a flat-packed state.

7. The foldable virtual reality viewer of claim 2, wherein at least a portion of at least one of the top wall, the bottom wall, the first side wall, or the second side is comprised of one or more overlapping layers.

8. The foldable virtual reality viewer of claim 2, further comprising a front wall flexibly connected to the bottom wall and attachable to the top wall such that a mobile device may be positioned against the front wall to face a generally hollow interior of the housing when the housing is in the operative state and when the front wall is attached to the top wall.

9. The foldable virtual reality viewer of claim 8, further comprising one or more friction pads adhered to the front wall.

10. The foldable virtual reality viewer of claim 8, wherein a joint flexibly connecting the front wall to the bottom wall is not flush with the intersection of the bottom wall and the first and second side walls.

11. The foldable virtual reality viewer of claim 8, wherein the front wall is taller than the first side wall and the second side wall when the housing is in the operative state.

12. The foldable virtual reality viewer of claim 8, wherein the front wall attaches to the top wall via velcro, hook and loop, or snap and tab.

13. The foldable virtual reality viewer of claim 2, further comprising a back wall flexibly connected to the top wall, the back wall including one or more lenses and being inset within the generally hollow interior of the housing when the housing is in an operative state.

14. The foldable virtual reality viewer of claim 13, wherein the back wall includes one or more tabs to engage the bottom wall when the housing is in an operative state.

15. The foldable virtual reality viewer of claim 13, wherein the back wall is separable from the housing.

16. The foldable virtual reality viewer of claim 2, further comprising a view divider flexibly connected to the top wall, the view divider having a first tab for insertion into the bottom wall and a second tab for insertion into a back wall.

17. The foldable virtual reality viewer of claim 2, wherein at least one joint separates (a) the top wall from the first side wall; (b) the first side wall from the bottom wall; (c) the bottom wall from the second side wall; and (d) the second side wall from the top wall.

18. The foldable virtual reality viewer of claim 17, wherein each joint is formed by fold lines and/or perforations in a common, parallel direction.

19. The foldable virtual reality viewer of claim 2, wherein at least a portion of the virtual reality viewer is comprised of plastic, metal, composite, wood, or cardboard.

20. A method of manufacturing a foldable virtual reality viewer comprising:
forming a body from a single sheet of material, the body having:
a first top wall section;
a view divider section connected to a first edge of the first top wall section;
a back wall section connected to a second edge of the first top wall section, the second edge of the first top wall section being substantially parallel to the first edge of the first top wall section;
a first side wall section connected to a third edge of the first top wall section, the third edge of the first top wall section being substantially perpendicular to the first edge of the first top wall section;
a bottom wall section connected to a first edge of the first side wall section, the first edge of the first side wall section being substantially parallel to the third edge of the first edge of the first top wall section;
a front wall section connected to a first edge of the bottom wall section, the first edge of the bottom wall section being substantially perpendicular to the first edge of the first side wall section; and
a second side wall section connected to a second edge of the bottom wall section, the second edge of the bottom wall section being substantially parallel to the first edge of the first side wall section.
